(19) United States
(12) Patent Application Publication
(10) Pub. No.: US 2008/0022155 A1
(43) Pub. Date: Jan. 24, 2008

(54) FACILITATING TESTING OF FILE SYSTEMS BY MINIMIZING RESOURCES NEEDED FOR TESTING

(75) Inventor: Andrew P. Wack, Millbrook, NY (US)

Correspondence Address: HESLIN ROTHENBERG FARLEY & MESITI P.C., 5 COLUMBIA CIRCLE, ALBANY, NY, 12203, US

(73) Assignee: INTERNATIONAL BUSINESS MACHINES CORPORATION, Armonk, NY (US)

(21) Appl. No.: 11/458,812

(22) Filed: Jul. 20, 2006

(51) Int. Cl. G06F 11/00

(52) U.S. Cl. 714/40

(57) ABSTRACT

The testing of components of processing environments is facilitated by minimizing the resources needed for testing. The requirements for storage and/or storage components, in one embodiment, is minimized by reducing the amount of data to be stored in storage associated with the component being tested, and/or simulating a larger pool of storage than is actually provided. To accomplish these tasks, a filter is used, which may be placed in different locations along a data path from the component to storage.

### TECHNICAL FIELD

This invention relates, in general, to testing components of processing environments, and in particular, to facilitating the testing of a component, such as a file system, of a processing environment by minimizing resources needed for the testing.

### BACKGROUND OF THE INVENTION

Demands on testing and testing environments are ever-increasing. For example, as the size and speed of computer file systems continue to grow, as well as their attendant storage subsystems, it is increasingly more difficult, expensive and time consuming to test file systems. The testing of large file systems places demands for large quantities of storage. Rapidly increasing file system size requirements have even outpaced the increase in drive storage density, necessitating larger numbers of disk drives in storage subsystems to test design requirements. Given that storage subsystems consist of a large portion of mechanical components, the cost increase is more than just the cost of the drives alone, but also in the labor to monitor and maintain such large storage pools.

Additionally, drive performance has not increased nearly at the same rate as storage density, yet user requirements have increased ten times over the past five years, with high-end file systems reaching speeds of over 100 GB/sec. This is driving a requirement for even larger numbers of disk drives for testing purposes to achieve the desired performance. With these requirements, come large investments in storage controllers, storage networks and adapters, and other infrastructure, to meet these high data rates.

### SUMMARY OF THE INVENTION

Based on the foregoing, a need exists for a capability that facilitates the testing of components of processing environments. As one example, a need exists for a capability to facilitate testing of files systems of a test environment. A need exists for a capability that enables testing, while minimizing the resources needed for testing.

The shortcomings of the prior art are overcome and additional advantages are provided through the provision of a method of facilitating testing of a component of a processing environment. The method includes, for instance, performing at least one of reducing an amount of data to be stored in storage associated with the component, the reducing discarding user data and storing metadata associated with the user data; and simulating a larger pool of the storage than is present for storing data; wherein the component is capable of being tested while minimizing an amount of one or more resources used for the testing.

System and computer program products corresponding to the above-summarized method are also described and claimed herein.

Additional features and advantages are realized through the techniques of the present invention. Other embodiments and aspects of the invention are described in detail herein and are considered a part of the claimed invention.

### BRIEF DESCRIPTION OF THE DRAWINGS

One or more aspects of the present invention are particularly pointed out and distinctly claimed as examples in the claims at the conclusion of the specification. The foregoing and other objects, features, and advantages of the invention are apparent from the following detailed description taken in conjunction with the accompanying drawings in which:

FIG. 1 depicts one embodiment of a processing environment to incorporate and use one or more aspects of the present invention;

FIG. 2 depicts one example of a filter to facilitate testing, in accordance with an aspect of the present invention;

FIG. 3A depicts one embodiment of filter logic associated with handling write requests, in accordance with an aspect of the present invention;

FIG. 3B depicts one embodiment of filter logic associated with handling read requests, in accordance with an aspect of the present invention;

FIG. 4A depicts another embodiment of filter logic associated with handling write requests, in accordance with an aspect of the present invention;

FIG. 4B depicts another embodiment of filter logic associated with handling read requests, in accordance with an aspect of the present invention;

FIG. 5 depicts one embodiment of a filter having a hash table used in accordance with an aspect of the present invention;

FIG. 6 depicts one embodiment of the logic associated with creating an appearance of a larger store than is actually present, in accordance with an aspect of the present invention;

FIG. 7 depicts one embodiment of a processing environment showing one or more locations for placement of the filter, in accordance with an aspect of the present invention; and

FIG. 8 depicts one embodiment of a computer program product incorporating one or more aspects of the present invention.

### BEST MODE FOR CARRYING OUT THE INVENTION

In accordance with an aspect of the present invention, the testing of components of processing environments is facilitated. As one example, a capability is provided to facilitate the testing of file systems in a test environment. The capability includes selectively reducing an amount of data to be stored in storage associated with the file system, and/or simulating a larger pool of storage than is present for storing the data. By reducing the amount of data to be stored, bottlenecks associated with storing the data are eliminated or significantly reduced allowing the performance of the file system itself to be tested under various conditions, including stress conditions. Similarly, by having the appearance of a larger pool of storage than is available, the file system is capable of being exercised to test the larger size without actually needing that amount of storage.

One or more aspects of the present invention enable a file system to be tested, while minimizing the amount of resources used for the testing. For example, the need for storage and/or storage components is reduced, yet enabling the efficient testing of a file system or other components of the environment that use the storage or storage components.

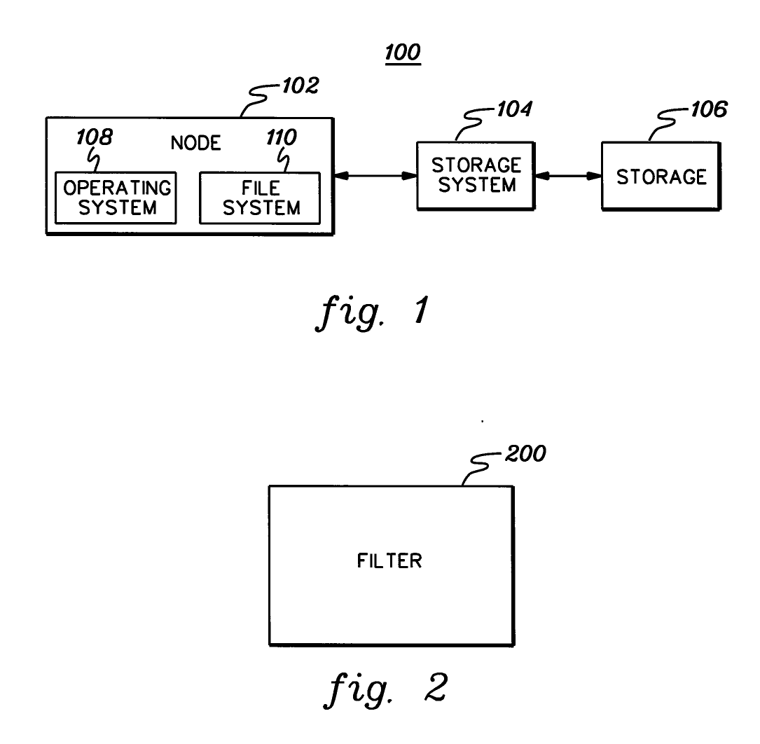

Although the capabilities of the present invention are capable of being included in many types of environments and/or apply to various components, one embodiment described herein is a test computing environment, in which a file system is tested. Further details regarding one example of this environment are described with reference to FIG. 1.

A test environment 100 includes, for instance, at least one node 102 coupled to a storage system 104, which is further coupled to storage 106. Node 102 is, for example, a SYSTEM p server, offered by International Business Machines Corporation (IBM®), Armonk, N.Y., which executes various programs, including user applications, an operating system 108, and a file system 110, to name a few.

Examples of operating system 108 include LINUX or AIX® offered by IBM®. Additionally, an example of file system 110 is the General Parallel File System (GPFS) offered by IBM®. IBM® and AIX® are registered trademarks of International Business Machines Corporation, Armonk, N.Y., U.S.A. Other names used herein may be registered trademarks, trademarks or product names of International Business Machines Corporation or other companies.

As is known, a file system facilitates access to user data by organizing and storing files, which include the user data. Various types of file systems exist. GPFS is a high-performance shared-disk file system that provides fast, reliable data access from one or more nodes of a homogeneous or heterogeneous environment. The file system is backed by storage 106, in that the data managed by the file system is stored in storage 106. Storage 106 includes one or more disks or any other types of storage media. Access to storage 106 is controlled by storage system 104. The storage system writes data to storage 106 and/or reads data therefrom. In one example, storage system 104 includes a storage network (e.g., storage area network (SAN)) and one or more storage controllers. An example of a storage controller and its backing storage is Fast T900 offered by International Business Machines Corporation.

In accordance with an aspect of the present invention, environment 100 further includes a filter 200 (FIG. 2), referred to herein as a test data storage simulator (TDSS), which is used to facilitate the testing of the file system or other components of the environment. The filter is capable of being placed in one or more locations within the environment, and specifically within the data chain from the file system to storage. However, in one example, it is included as part of storage system 104.

The test data storage simulator seeks to eliminate or significantly reduce the cost and complexity of large storage subsystems without affecting application performance in a test environment. As one example, the test data storage simulator focuses on the reduction of data that is to be stored, while still storing metadata, such that file system integrity is maintained. By reducing the amount of data that is actually transmitted to the storage subsystem, it permits the appearance of very large and very fast storage subsystems, when only a small amount of storage is actually present. In a further example, the test data storage simulator simulates a larger pool of storage than is present for storing data. The capabilities of reducing data and of simulating a larger pool of storage may be used alone or in combination with one another.

The functionality of the filter depends on the tasks to be performed, which are based on, for instance, the type of file system being tested and the desired test goals. For example, if a desired test goal is maximum file system bandwidth, then the filter throws away blocks of user data it receives on writes, and intercepts those blocks on read requests and returns empty or other predefined blocks of data. To achieve this, the user data is to be separated from the metadata. Thus, if the file system being tested does not separate the data from the metadata, then the filter is to perform this task, as well. However, if the file system is one in which it does separate user data from metadata, then this task need not be part of the filter.

As a further example, if the desired goal is to give the appearance of nearly unlimited storage, then the filter includes a hash table to map virtual blocks of storage to real storage. Many other functions and/or characteristics of the filter may be added or changed to provide the desired test goals. Those described herein are provided simply as examples.

Further details regarding the logic associated with the filter are described below. In particular, various examples are provided, each depending on the desired test goal(s) and/or the type of file system. Although examples are provided below, these examples are not exhaustive. There are many other examples that exemplify one or more aspects of the present invention.

In one example, the environment includes a file system, such as GPFS, that separates the user data from the metadata. The test goal is to check the performance of the file system, and the test application is not concerned with the actual data written or read. In this example, the user data takes one path to storage, while the metadata takes another path. Since the data and metadata are separate and the metadata is not affected by an aspect of the present invention, the filter is placed on the data side of the path to storage.

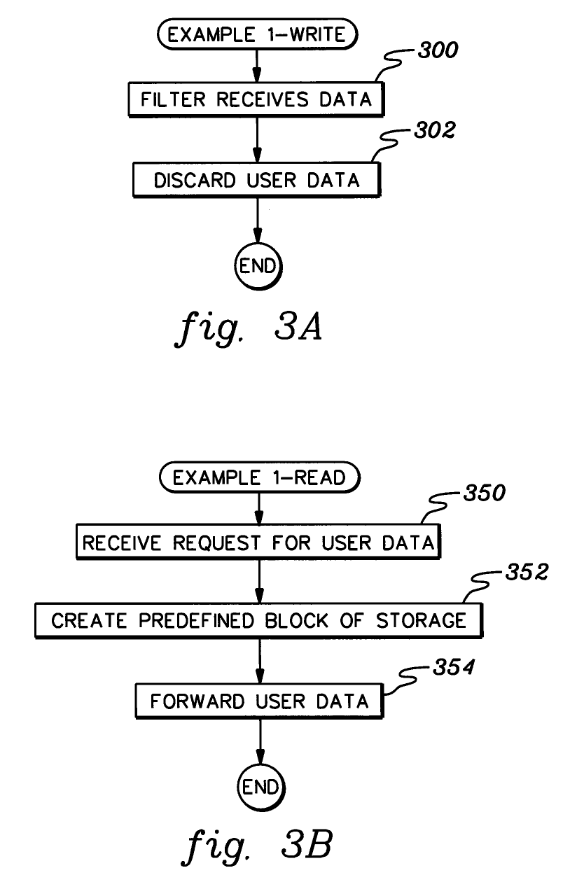

One embodiment of the filter logic to accomplish the goals of this example is described with reference to FIG. 3 (i.e., FIG. 3A and FIG. 3B, collectively). In particular, FIG. 3A depicts one embodiment of the logic associated with a write request, and FIG. 3B depicts one embodiment of the logic associated with a read request.

Referring to FIG. 3A, in one example, the filter receives data to be stored in storage, in response to a write request, STEP 300. Since this data is user data, the filter discards the data, STEP 302. The user data is not stored in storage; only the metadata that describes the blocks of storage containing that data is stored. In this particular example, the metadata is sent along a different path, and therefore, the filter has no effect on the metadata. However, in a further embodiment, the metadata may be sent to storage via the filter and the filter enables the storage of that metadata.

The discarding of user data while saving the metadata on writes, permits the file system to maintain its file structure. However, since the metadata is typically generated at 1/100 to 1/1000 the rate of data, it allows the same subsystem to simulate disk performance of up to 1000 times, as long as the upstream chain can handle the data rates. In addition, this provides the capability of virtually unlimited file system size simulation, as there is no restriction on reporting back to the operating system a particular capacity. Any desired capacity can be reported back to the file system.

Since the user data is discarded on writes, predefined data is recreated, in response to a read request. One embodiment of the logic associated with the filter processing a read request is described with reference to FIG. 3B.

In one example, in response to the filter receiving a request for user data, STEP 350, the filter creates one or more predefined blocks of storage to be returned to the user, STEP 352. The recreated data includes all zeros or some other defined pattern that the application under test expects to receive (not necessarily the data originally written to storage). The application does not care about the particular data. This user data is then forwarded to the application, STEP 354.

In a further example, the environment includes a file system, such as the AIX Journaled File System (JFS) offered by IBM®, that does not separate user data from the metadata. In this example, the filter is constructed to have the ability to determine which blocks of data are to be saved to actual storage and which are to be discarded. This version of the filter is implemented with the same performance characteristics as the first example.

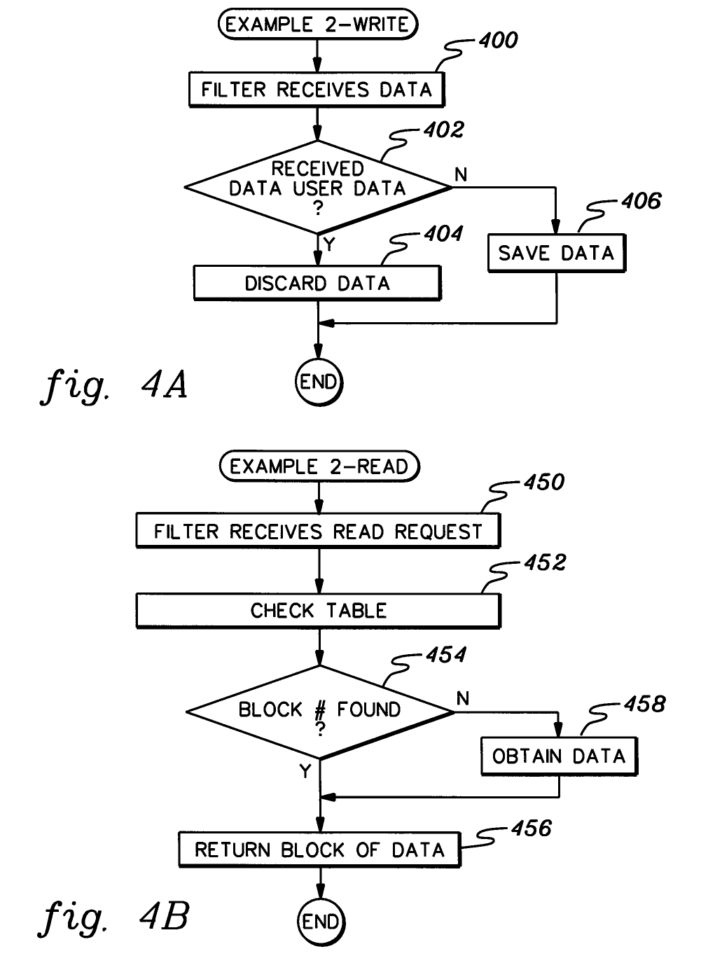

One embodiment of the filter logic to accomplish the goals of this example is described with reference to FIG. 4 (i.e., FIG. 4A and FIG. 4B, collectively). In particular, FIG. 4A depicts one embodiment of the logic associated with a write request, and FIG. 4B depicts one embodiment of the logic associated with a read request.

Referring to FIG. 4A, the filter receives data (e.g., a data block) from an application, STEP 400. The filter determines whether the received data is user data or metadata, INQUIRY 402. If the received data block is user data, then that data is discarded, STEP 404. However, if the received data is metadata, then that data is saved to storage, STEP 406.

In one example, to determine whether the data is user data or metadata, the filter is programmed to check for specific patterns of data. For example, the filter checks for all zeros. If, in this particular example, a block of data has all zeros, then the data is considered user data and the block number is recorded in a data structure, such as a table, and the data is discarded. If, however, the data block does not include all zeros, the data is assumed to be metadata and is passed on to the disk subsystem to be stored. In this embodiment, the application producing the data is programmed to only write empty blocks of data.

In response to the filter receiving a read request, STEP 450 (FIG. 4B), the table is consulted, STEP 452, and if the block number is found, INQUIRY 454, a zero block of data is returned without passing requests further down the I/O subsystem chain, STEP 456. For instance, a block of data including all zeros (or some other predefined pattern) is created and returned without accessing storage. However, if the block number is not found, the data is obtained from storage, STEP 458, and returned, STEP 456. This version of the filter does not accommodate the unlimited disk size capability of the previous version, because an unlimited size cannot be guaranteed, since it is not known which block numbers will be used for metadata, and thus, all block numbers map to real storage.

In a variant to the above example, data validation is enabled. A pattern generating function f(x) is employed. F(x) is a function that generates a block of data, equivalent in size to a storage block that starts with the value x, and then contains a deterministic sequence of values. F(x) is known to both the application and the filter. Thus, the application is modified to send blocks of data generated by f(x), and the filter checks to see if for each block it matches f(x), where x is the first byte in the incoming block. If there is a match, there is no need to store the data in the storage subsystem, only the value of x in the table. If it does not match, the block is considered metadata, and as such is stored on disk. In the unlikely event that a metadata block matches f(x), this does not cause a problem, since the block can be created by the function on reads. When a request to read a block comes into the filter, it first checks to see if there is an entry in the table, and if so, it recreates the data using the x value in the table passed to the generating function. If not, the request is passed on to the storage subsystem for retrieval. Depending on the generating function used, it can be validated that there is no data corruption in the storage subsystem up to the point where the filter is located.

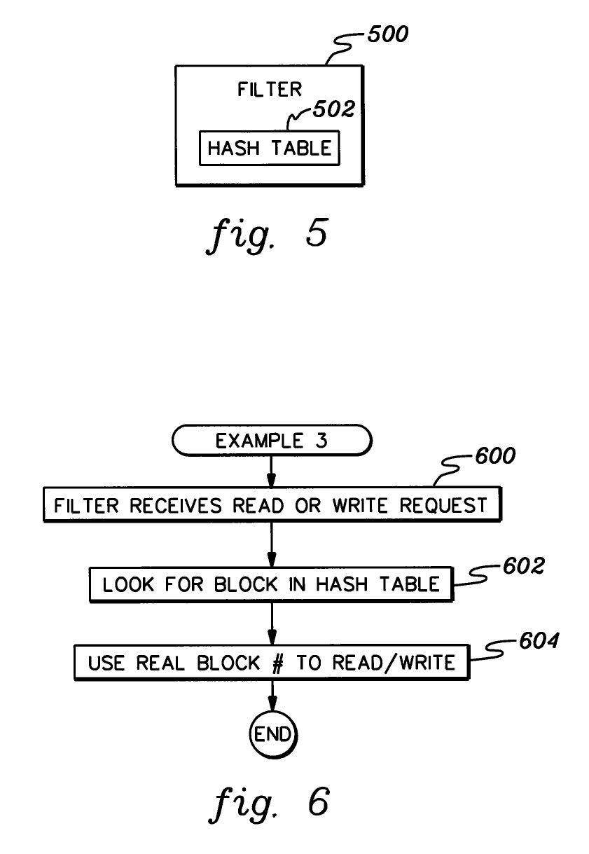

In yet a further example, the filter is used to give the appearance of a nearly unlimited storage system size. That is, a certain amount of physical storage is present, but the file system believes there is much more storage. This “additional storage” is not backed by physical storage. There is only the appearance of additional storage. In this example, a filter 500 (FIG. 5) includes a hash table 502 or other type of data structure to map virtual blocks of storage to real storage. This permits the filter to report back to the file system that a much larger store is available than the actual storage present. One embodiment of this processing is described with reference to FIG. 6.

Initially, the filter receives a read or write request, STEP 600. The block number of the requested block of data is looked-up in the hash table, which stores the real block number that includes the desired data on the backend store, STEP 602. The block number in the request is mapped to the real block number, and the real block number is used to perform the read or write, STEP 604. This allows applications to test the file system with large block values (up to the capacity of the file system), without actually having a large quantity of physical storage. In this embodiment, the application notices that the file system reports being full, long before it expects, since the filter reports no more available storage when the backend storage is full, not when the simulated file system is full.

This embodiment can be combined with examples one and two above to allow high performance, large file system testing. As one example, since example two only requires backend storage for metadata, the sparse implementation described above allows backend stores to fully simulate file systems of up to a thousand times the actual physical storage.

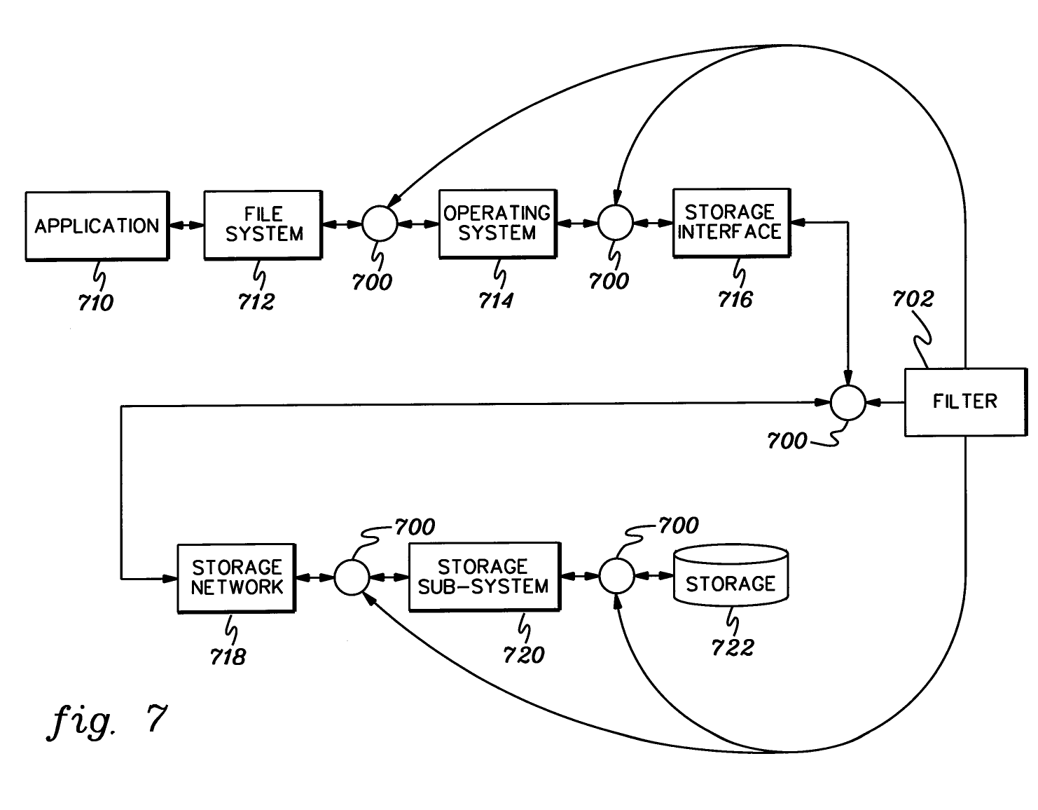

The filter used to facilitate testing of file systems and/or other components of the processing environment can be strategically placed at different locations in the data chain. This is pictorially depicted in FIG. 7. In FIG. 7, each circle 700 depicts an example of a location in the path from application to storage in which filter 702 may be placed. In this example, data moves from an application 710 into a file system 712, which in turn uses storage resources managed and presented by an operating system 714. The data flows through a storage interface 716, through a storage network 718 and a storage subsystem 720 before arriving at storage 722. In other embodiments, one or more of the storage components may be omitted, such as the storage network and/or the storage subsystem.

Shifting the position of the filter alters the cost involved to achieve a desired level of performance. For example, inserting the filter between the file system and operating system results in the maximum savings of data storage hardware, at the expense of accuracy of the simulated file system. In contrast, inserting the filter between the storage subsystem and storage maximizes the accuracy of the simulation (since all the latency, bandwidth and other characteristics of the previous steps are all present) at the expense of adding additional hardware costs. Many other variations are possible.

The filter can be implemented in software, hardware, firmware or any combination thereof. Further, one or more aspects of the present invention can be included in an article of manufacture (e.g., one or more computer program products) having, for instance, computer useable media. The media has therein, for instance, computer readable program code means of logic (e.g., instructions, code, commands, etc.) to provide and facilitate the capabilities of the present invention. The article of manufacture can be included as a part of a computer system or sold separately.

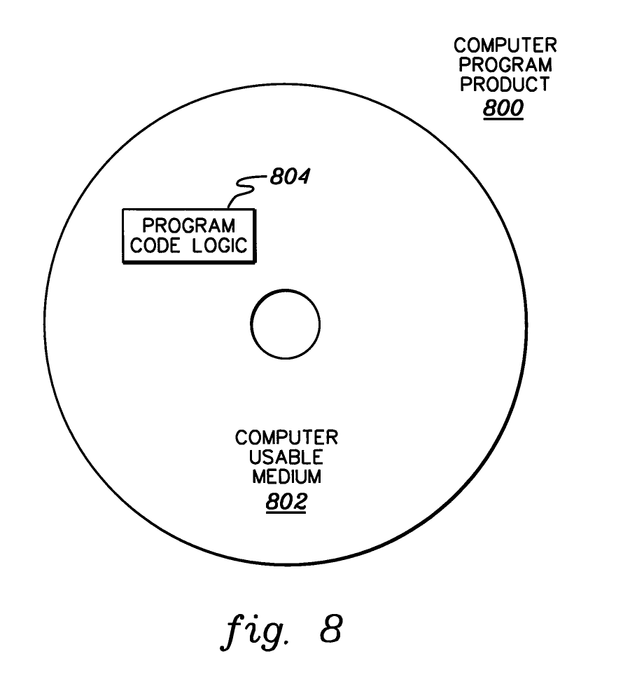

One example of an article of manufacture or a computer program product incorporating one or more aspects of the present invention is described with reference to FIG. 8. A computer program product 800 includes, for instance, one or more computer usable media 802 to store computer readable program code means or logic 804 thereon to provide and facilitate one or more aspects of the present invention. The medium can be an electronic, magnetic, optical, electromagnetic, infrared, or semiconductor system (or apparatus or device) or a propagation medium. Examples of a computer readable medium include a semiconductor or solid state memory, magnetic tape, a removable computer diskette, a random access memory (RAM), a read-only memory (ROM), a rigid magnetic disk and an optical disk. Examples of optical disks include compact disk-read only memory (CD-ROM), compact disk-read/write (CD-R/W) and DVD.

A sequence of program instructions or a logical assembly of one or more interrelated modules defined by one or more computer readable program code means or logic direct the performance of one ore more aspects of the present invention.

Advantageously, a capability is provided to facilitate the testing of components of a processing environment. In one example, a file system is tested at much higher performance or capacity while reducing the costs of the file system. Testing of applications and other steps in the file system chain (see, e.g., FIG. 7) are limited by the performance characteristics for each step in the chain. Performance characteristics include speed (bandwidth), capacity (size), and latency (response time). The entire file system is constrained by the most restrictive of these parameters in the chain.

The filter seeks to remove some or all of these limitations to allow testing of the file system at much higher performance or capacity, while reducing the cost of the entire file system. The filter may be inserted into the chain at various locations and allows the appearance of dramatically improved speed, capacity and latency of the remaining portion of the chain after the filter. In this way, during testing, cost/performance trade-offs may easily be realized by varying the position of the filter in the chain. For example, further to the left in the chain allows dramatically improved performance, at the expense of less testing of the entire chain. The invention allows simulation of larger stores and/or simulation of much higher performance. There are many implementation variants of the filter depending on the desired characteristics to be simulated, as well as the ability/desire to modify the testing application.

As described above, the characteristics of the filter can be varied depending the desired test goals. For example, in an environment where metadata is separate from data, if the goal is to maximize file system bandwidth, the filter simply discards blocks of user data it receives on writes, and on read requests, it intercepts those and returns empty (or other predefined) blocks of data. File system integrity is maintained by virtue of all the metadata taking an alternate path around the filter and being placed in actual storage. In this environment, besides maximum throughput, nearly unlimited storage is also simulated as metadata for file systems typically requires only 1/1000 of storage of user data. This one example does have the restriction, however, that the application cannot expect to retrieve the user data it stores, and only limited data checking is possible. However, in many test situations this is not a limitation, as its desired goal is testing the actual performance of the file system and its reaction under stress loads.

One or more aspects of the present invention seek to eliminate or significantly reduce the cost and complexity of large storage systems without affecting application performance in a test environment. For example, the filter focuses on the reduction of data that is to be stored, such that user data is discarded, but metadata is saved, thus maintaining the integrity of the file system. By reducing the amount of data that is actually transmitted to the storage subsystem, it permits the appearance of very large and very fast storage subsystems when only a small amount of storage is actually present. By selectively discarding data, the storage, as well as storage network requirements down the stream of the filter, can be dramatically reduced. Thus, in one or more aspects of the present invention, a capability is provided to recognize and save file system metadata that is to be stored to prevent the file system from being corrupted, while discarding and recreating predefined user data. Further, depending on test requirements, in one aspect of the present invention, data is passed along to storage, while still presenting a simulated view that the storage pool is much larger than is actually physically present.

Although various embodiments are described above, these are only examples. For instance, processing environments other than the one depicted and described herein may incorporate one or more aspects of the present invention. As examples, more than one node may be present and an operating system other than LINUX or AIX may be used. Further, the environment may include more than one operating system and/or more than one file system. File systems other than GPFS or JFS may also benefit from one or more aspects of the present invention. Additionally, components other than file systems may also benefit from one or more aspects of the present invention. Further, the components of the storage system may be different than that described herein. That is, additional, less or different components may be used.

In yet a further example, an environment may include an emulator (e.g., software or other emulation mechanisms), in which a particular architecture or subset thereof is emulated. In such an environment, one or more emulation functions of the emulator can implement one or more aspects of the present invention, even though a computer executing the emulator may have a different architecture than the capabilities being emulated. As one example, in emulation mode, the specific instruction or operation being emulated is decoded, and an appropriate emulation function is built to implement the individual instruction or operation.

In an emulation environment, a host computer includes, for instance, a memory to store instructions and data; an instruction fetch unit to fetch instructions from memory and to optionally, provide local buffering for the fetched instruction; an instruction decode unit to receive the instruction fetch unit and to determine the type of instructions that have been fetched; and an instruction execution unit to execute the instructions. Execution may include loading data into a register for memory; storing data back to memory from a register; or performing some type of arithmetic or logical operation, as determined by the decode unit. In one example, each unit is implemented in software. For instance, the operations being performed by the units are implemented as one or more subroutines within emulator software.

Further, a data processing system suitable for storing and/or executing program code is usable that includes at least one processor coupled directly or indirectly to memory elements through a system bus. The memory elements include, for instance, local memory employed during actual execution of the program code, bulk storage, and cache memory which provide temporary storage of at least some program code in order to reduce the number of times code must be retrieved from bulk storage during execution.

Input/Output or I/O devices (including, but not limited to, keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems, and Ethernet cards are just a few of the available types of network adapters.

The capabilities of one or more aspects of the present invention can be implemented in software, firmware, hardware, or some combination thereof. At least one program storage device readable by a machine embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted, or modified. All of these variations are considered a part of the claimed invention.

Although preferred embodiments have been depicted and described in detail there, it will be apparent to those skilled in the relevant art that various modifications, additions, substitutions and the like can be made without departing from the spirit of the invention and these are therefore considered to be within the scope of the invention as defined in the following claims.

What is claimed is:

1. A method of facilitating testing of a component of a processing environment, said method comprising:
performing at least one of:
reducing an amount of data to be stored in storage associated with the component, said reducing discarding user data and storing metadata associated with the user data; and
simulating a larger pool of the storage than is present for storing data;
wherein the component is capable of being tested while minimizing an amount of one or more resources used for the testing.

2. The method of claim 1, wherein the component comprises a file system, and the processing environment comprises a test environment.

3. The method of claim 1, wherein the one or more resources includes at least one of the storage and a storage component.

4. The method of claim 1, wherein the reducing comprises separating the user data and the metadata.

5. The method of claim 1, wherein the performing is included in a filter, said filter being placed on a data path from the component to the storage.

6. The method of claim 5, wherein placement of the filter depends on at least one of one or more desired test goals and cost.

7. The method of claim 1, wherein the performing comprises reducing the amount of data, and wherein the method further comprises creating predefined user data, in response to a read request.

8. The method of claim 7, wherein the predefined user data is of a form expected by a test application issuing the read request.

9. The method of claim 7, further comprising validating the predefined user data.

10. The method of claim 1, wherein the performing comprises simulating the larger pool, and wherein the simulating comprises mapping a block number of a storage block that is not physically present in storage to a block number of a storage block that is present in storage.

11. The method of claim 10, wherein the mapping employs a hash data structure of a filter that performs the simulating.

12. A system of facilitating testing of a component of a processing environment, said system comprising:
a filter to perform at least one of:
reduce an amount of data to be stored in storage associated with the component, wherein user data is discarded and metadata associated with the user data is stored; and
simulate a larger pool of the storage than is present for storing data;
wherein the component is capable of being tested while minimizing an amount of one or more resources used for the testing.

13. The system of claim 12, wherein the filter is adapted to separate the user data and the metadata to enable discarding of the user data.

14. The system of claim 12, wherein placement of the filter in a data path from the component to the storage depends on at least one of one or more desired test goals and cost.

15. The system of claim 12, wherein the filter reduces the amount of data to be stored, and wherein the filter is further adapted to create predefined user data, in response to a read request.

16. The system of claim 12, wherein the filter comprises a hash data structure to map a block number of a storage block that is not physically present in storage to a block number of a storage block that is present in storage to simulate the larger pool.

17. An article of manufacture comprising:
at least one computer usable medium having computer readable program code logic to facilitate testing of a component of a processing environment, the computer readable program code logic comprising:
perform logic to perform at least one of:
reducing an amount of data to be stored in storage associated with the component, said reducing discarding user data and storing metadata associated with the user data; and
simulating a larger pool of the storage than is present for storing data;
wherein the component is capable of being tested while minimizing an amount of one or more resources used for the testing.

18. The article of manufacture of claim 17, wherein the reducing comprises logic to separate the user data and the metadata.

19. The article of manufacture of claim 17, wherein the perform logic reduces the amount of data, and wherein the article of manufacture further comprises logic to create predefined user data, in response to a read request.

20. The article of manufacture of claim 17, wherein the perform logic simulates the larger pool, and wherein the simulating comprises logic to map a block number of a storage block that is not physically present in storage to a block number of a storage block that is present in storage.
